(19) United States
(12) Patent Application Publication
(10) Pub. No.: US 2017/0009432 A1
(43) Pub. Date: Jan. 12, 2017

(54) Wireless Automation Systems and Methods for Controlling Fluid Pressure in a Building

(71) Applicant: 9346678 CANADA INC., Montreal (CA)

(72) Inventors: Serge LAPOINTE, Montreal (CA); Benoit BOUCHER, Ste-Elisabeth (CA)

(21) Appl. No.: 15/206,894

(22) Filed: Jul. 11, 2016

Related U.S. Application Data
(60) Provisional application No. 62/190,522, filed on Jul. 9, 2015.

(51) Int. Cl. E03B 7/07; G05B 19/416; F17D 5/06

(52) U.S. Cl. CPC E03B 7/071; F17D 5/06; E03B 7/077; G05B 19/416; G05B 2219/37371

(57) ABSTRACT

A wireless control system for fluids, such as water or gas, controls an electronic valve mechanism located at the main fluid entrance of buildings. The valve is kept closed when no request is made for use of the aquifer or gas system, thus lessening the pressure on the plumbing during the non-use of the system and greatly reduces risk of damage when a break occurs in plumbing. The valve can be controlled by sensors, which could be wirelessly and securely connected; by a central unit accessible via a screen placed directly on the unit; and through several types of interfaces available for better flexibility of the control system. A web interface can be accessed via a computer or mobile on the local network via Wi-Fi or from outside via VPN or web address and a specific port pointed to the previously configured network.

### CROSS-REFERENCE TO RELATED APPLICATIONS

The present patent application claims the benefits of priority of commonly assigned U.S. Patent Application No. 62/190,522, entitled “Wireless Home Automation Systems and Methods for Controlling Water Pressure” and filed at the United States Patent and Trademark Office on Jul. 9, 2015.

### FIELD OF THE INVENTION

The present disclosure generally relates to a fluid control system and method, such as for gas or water, and more particularly to wireless home automation systems and method for controlling water pressure in a building. The present disclosure also relates to business methods for providing surveillance and maintenance services for buildings equipped with the wireless home automation system.

### BACKGROUND OF THE INVENTION

Water or gas supplies connected to a building are typically controlled only at the points of service, e.g., faucets, valves and appliances that connect to the water or gas supply, and which provide individual shut-off for fluid flow. The building fluid supply connection is typically controlled by a manual external valve that can be used to shut-off fluid flow in the event of an emergency leak or for servicing the fluid supply system plumbing or replacing appliances.

Water flooding due to plumbing or appliance failures is a major source of damage to structures and fixtures such as carpeting, wood flooring, wallboard, etc. The most frequent water supply emergency events are failure due to freezing temperatures inside the water supply plumbing and failure of the water heater tank. A freezing condition usually occurs when the building is unoccupied, for example, a vacation home that is unoccupied during winter is at risk for damage due to bursting of water supply lines due to freezing. Other water supply emergency events may occur when the building is unoccupied, such as failure of a polyvinyl chloride (PVC) plumbing joint, or water heater tank wall erosion and leakage.

Since water pressure needs to be available while persons are present in the building, the supply pressure must be available when the building is occupied. For instance, such systems are disclosed in U.S. Pat. Nos. 6,123,093 (D'Antonio et al.), U.S. Pat. No. 6,491,062 B1 (Croft), or U.S. Pat. No. 6,691,724 B2 (Ford), and U.S. patent applications no. US 2012/0291886 (Rivera) or US 2006/0007008 A1 (Kates).

Some of these systems have been implemented to shut off the building water supply in response to detection of leaks using detectors located near water heaters, sinks, etc. However, these systems only protect against leaks where water reaches the detectors and could require a large number of detectors for adequate coverage. Other systems have been developed that measure water flow and shut off the water supply if excessive flow occurs based on whether or not the building is occupied as programmed manually by a switch. The flow type systems typically use flow meters that are incapable of detecting water flows below a certain threshold, such as a dripping faucet.

On a cost level, increasingly, municipalities are coming to impose taxes on water consumption, and it becomes important for residents to control their personal consumption, and ensure that their consumption is properly restricted and monitored. Furthermore, the aquifer network of a building which is permanently subjected to the stress of the water pressure provided by the municipality, typically 60 psi, can induce leaks, accidents, damages and accelerated wear of the plumbing system. Such accidents increase the insurances costs for the buildings.

Therefore, it would be desirable to provide a method and system for controlling a building water supply to prevent flooding. It would further be desirable to control a building water supply in a manner that automatic water users are able to obtain water, while preventing leaks that occur while the water supply is not being used. There would be also a need for a business method providing secured and reliable home automation maintenance services of the aquifer system of a building, such services using modern ways of communications such as web interface and mobile applications.

Regardless of known fluid pressure control systems, there is a need for a fluid pressure control system that allows a user to maintain as a defaulting position to cut the pressure of the aquifer or gas system when not in use, while allowing to have water or gas on demand where need occurs. There is further a need for a fluid pressure control system that allows the user to remotely control and monitor the system.

Therefore, despite ongoing developments in the field of water and gas pressure control systems, there is a need for novel fluid pressure control systems that can mitigate some of the shortcomings of the prior art.

### SUMMARY OF THE INVENTION

The aforesaid and other objectives of the present invention are realized by generally providing a computer-implemented system and method designed to control an electronic valve mechanism located at the main water or gas entrance of a building, such as houses, residential real estate units, as well as commercial, industrial and institutional buildings.

In particular, the invention is designed to keep the valve closed, as a default setting, when no request is made for use of the aquifer system, thus lessening the pressure on the plumbing at all times during the non-use of the aquifer system and thus reducing the risk of damage when a break occurs in the plumbing.

The invention is directed to a computer-implemented system to automatically control fluid distribution in a building, the system comprising:
a valve located at a main entrance of a fluid distribution system of the building;
an electronic valve mechanism operatively connected to the valve to open or close the valve;
at least one sensor for detecting activities occurring in or near the building, each sensor being operatively connected to the electronic valve mechanism; and
a computerized control unit in communication with the electronic valve mechanism and each sensor for controlling the opening and closing of the valve;
   wherein the computerized control unit comprises at least one processor and a computer-readable medium having stored thereon computer-readable instructions that, when executed, cause the processor to:
command the electronic valve mechanism to maintain the valve in locked position in the absence of activities detected by the said at least one sensor in or near the building, or
command the electronic valve mechanism to open the valve when an activity is detected by the said at least one sensor.

According to a preferred embodiment, the system further comprises a by-pass valve fluidly connected in parallel to the valve and the electronic valve mechanism to allow a person to open the circulation of the fluid even if the valve is closed or in case of a malfunction of the electronic valve mechanism. The by-pass may be manually operated by the person.

An anti-backflow valve fluidly connected to the main fluid entrance and upwind of the electronic valve mechanism may be installed to protect the valve and the electronic valve mechanism from a backflow of fluid, such as water.

According to a preferred embodiment, the building may comprise a plurality of apartments, wherein each apartment comprising its own valve and electronic valve mechanism and at least one sensor. In another embodiment, the building is a hotel comprising a plurality of hotel rooms, wherein each room preferably comprises its own valve and electronic valve mechanism and at least one sensor.

The activities causing the electronic valve mechanism to open the valve may be, for example, a fluid leakage in the room, and an appliance requiring incoming fluid. A current transformer may operatively be connected to the appliance and adapted to send a signal to open the electronic valve mechanism when an income of fluid is required by the appliance.

The invention is further directed to a computer-implemented method to automatically control fluid distribution in a building, the method comprising the steps of:
a) detecting at least one activity using at least one sensor located in or near a building, each sensor being operatively connected to an electronic valve mechanism operatively connected to a valve, the electronic valve mechanism being adapted to open or close the valve; and
b) sending information detected in step a) to a computerized control unit in communication with the electronic valve mechanism and each sensor to command the electronic valve mechanism to open the valve if activities are detected in step a), or to keep the valve closed if no activity is detected in step a).

According to a preferred embodiment, the fluid may be water and the method may further comprise the step of measuring a water pressure upwind of the valve, and increasing the water pressure if said pressure is below a given threshold.

The method may further comprise the step of detecting a malfunction of the electronic valve mechanism and by-passing the valve and electronic valve mechanism by manually opening a by-pass valve fluidly connected in parallel to the valve and the electronic valve mechanism to allow circulation of the fluid even if the valve is closed.

The activities that cause the electronic valve mechanism to open the valve may be, for example, a fluid leakage in a room, and an appliance requiring incoming fluid. The method may further comprise the step of sending a signal to open the electronic valve mechanism when an income of fluid is required by the appliance preferably using a current transformer operatively connected to the appliance.

The invention is yet further directed to a business method of providing automatic surveillance and maintenance services for a plumbing system of a building to a member of an organization, the building being equipped with a computer-implemented system as described herein, the method comprising performing the steps of:
a) offering membership in the organization that provides services for the plumbing system of the building;
b) receiving requests for membership in the organization from prospective members;
c) granting membership to prospective members that have requested membership in the organization and satisfy pre-determined criteria required for membership;
d) receiving requests from the members of the organization to monitor the plumbing system when said members are away from the building for a period of time; and
e) providing the surveillance and maintenance services to the members of the organization who requested said services.

According to a preferred embodiment, the surveillance and maintenance services are:
notifying the members if a fluid leakage in a room is detected;
notifying the members if an appliance requiring an income of fluid is used; and/or
allowing the members to send a signal to the electronic valve mechanism to lock the valve.

The method may further comprise the step of notifying the members when the maintenance and surveillance services have been used.

According to a preferred embodiment, the requests are made via a website of the organization, a mobile application, or a telephone.

Still according to a preferred embodiment, the pre-determined criteria are to have bought and installed the computer-implemented system described herein.

The system in accordance with the principles of the present invention is designed to allow a user to control an electronic valve mechanism located at the main water entrance of buildings, such as houses, residential real estate units, as well as commercial and institutional buildings and hotels.

The system according to the present invention shall keep the valve closed as a default setting, when no request is made for use of the aquifer system, thus lessening the pressure on the plumbing during the non-use of the aquifer system and thus reducing the risk of damage when a break occurs in the aquifer system.

The system according to the present invention allows the valve to open when there is a signal captured in or near the building where the sensors are installed, such as, but not limited to a faucet, a shower, in the bathroom, in the kitchen, or with the current transformers (CT) when there is a demand for water in a an appliance such as a laundry machine, a dishwasher, a fridge, an automatic watering system or the like. The valve remains open for a given time period that can be eventually set up by a timer.

Alternatively, the system may also be operated manually. The user can set an open or closed status of the valve, for a finite or indefinite period of time, directly on the central unit, from a switch button device for indoor and outdoor use, or from the interface of a portable computer or of a mobile phone.

The system may be used in a hotel comprising a plurality of hotel rooms. Each room may be equipped with its own valve and electronic valve mechanism and at least one sensor. In a more preferred embodiment, the door room's key and lock system, such as a door lock opened using a key card, may be also used as the sensor to send the signal to the electronic valve mechanism to open the valve. Thus, the sensor conjointly with the key system allows closing the electric circuit of the room allowing the tenants to use electricity and opening the valve to use water.

Among the advantages of the present invention, it should be also stressed that the fact that the aquifer network of a building shall not permanently be subjected to the stress of the water pressure provided by the municipality, typically 60 psi, has many benefits to reduce accidents, damages and accelerated wear: for example, the hot water tank will have its lifetime substantially extended, water hammer so common in older installations will be avoided, reducing accidents due to breakage of older facilities.

### BRIEF DESCRIPTION OF THE DRAWINGS

The above and other objects, features and advantages of the invention will become more readily apparent from the following description, reference being made to the accompanying drawings in which:

FIG. 1 is a diagram illustrating different modules of a water pressure control system in accordance with one embodiment of the present invention.

FIG. 2 is a schematic view of water demand detection scheme by current transformer in connection with a water pressure control system shown in FIG. 1 in accordance with one embodiment of the present invention.

FIG. 3 is a workflow diagram presenting steps of the method for controlling the water pressure in accordance with one embodiment of the present invention.

FIGS. 4a to 4g illustrate different environments where the system and movement detectors and/or leak detectors can be installed in the building or near the building in accordance with preferred embodiments of the invention.

FIGS. 5a and 5b are pictures illustrating different environments where a leak detector can be installed in the building in accordance with preferred embodiments of the invention.

FIG. 6 is a screen shot of the user interface of the central unit, of a computer programs or mobile applications forming part of the water control system shown in FIG. 1, in accordance with preferred embodiments of the invention.

FIG. 7 is a diagram illustrating the business method in accordance with a preferred embodiment of the invention.

FIG. 8 illustrates a mesh network technology known in the art.

FIGS. 9a to 9d illustrate hydraulic installations according to different embodiments of the invention.

FIGS. 10a to 10d illustrate typical installations according to different embodiments of the invention such as in a house, a duplex, a condominium and a hotel.

FIG. 11 is an illustration of an installation of the system in a building according to a preferred embodiment of the invention.

### DETAILED DESCRIPTION OF THE PREFERRED EMBODIMENT

A novel water pressure control system will be described hereinafter. Although the invention is described in terms of specific illustrative embodiment(s), it is to be understood that the embodiment(s) described herein are by way of example only and that the scope of the invention is not intended to be limited thereby.

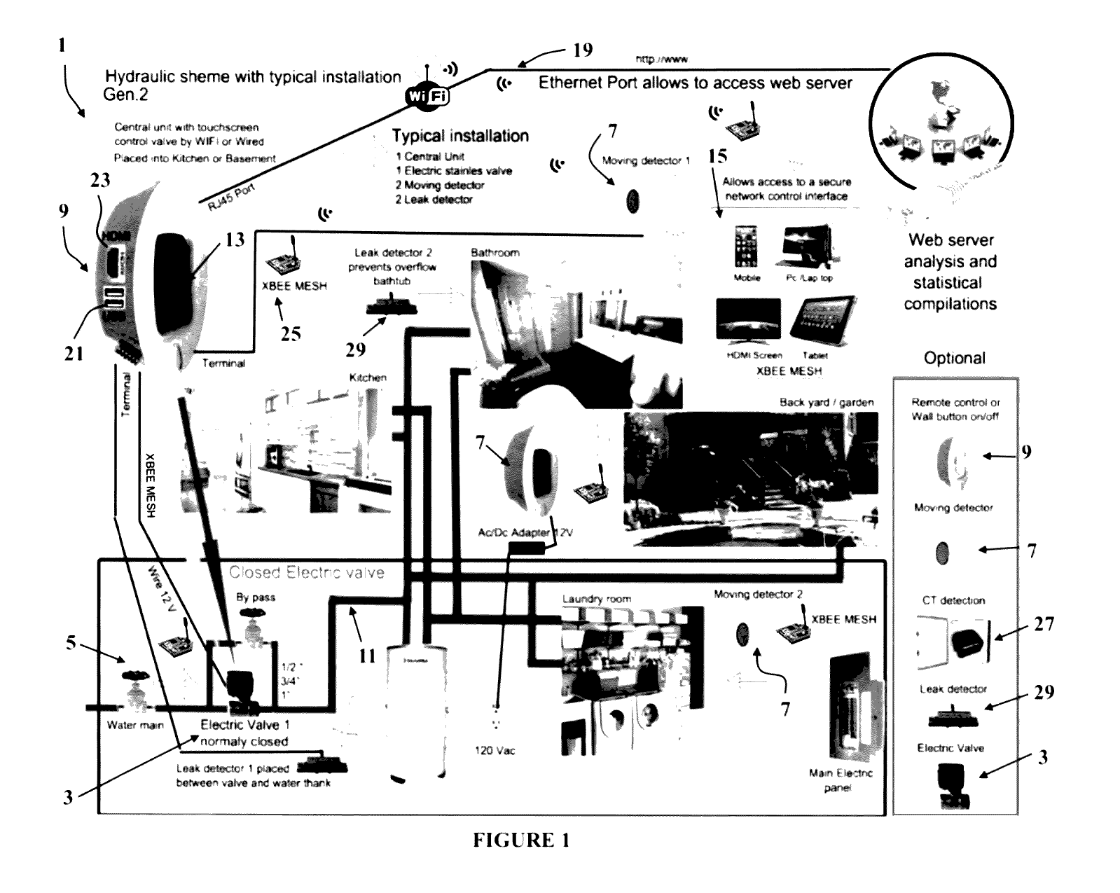

A computer-implemented system to automatically control a valve located at the main water or gas entrance of a building according to one embodiment of the invention is illustrated on FIG. 1.

The system 1 first comprises an electronic valve mechanism 3 operatively connected to a valve 5 to open or close the valve, such as, for example of the CWX-15Q/n 2-way electric valve model, manufactured by Tianfei HighTech Valve co. ltd.

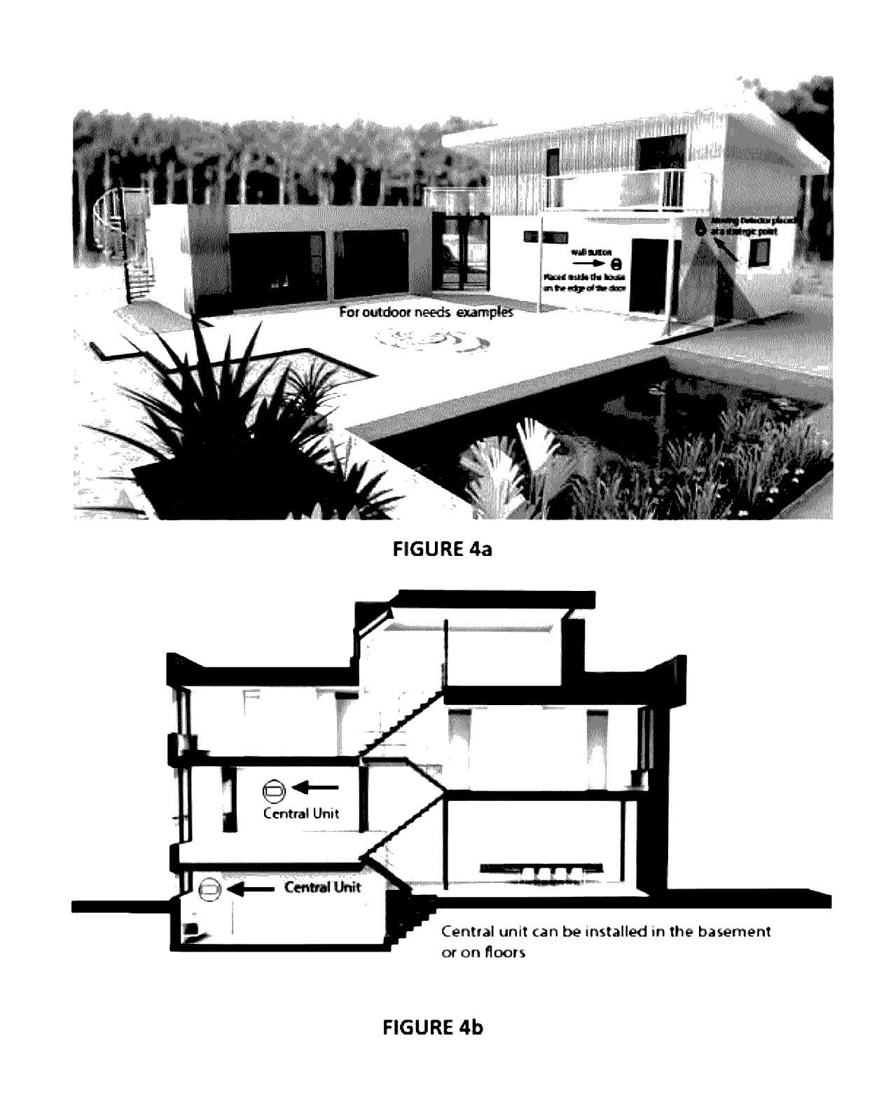

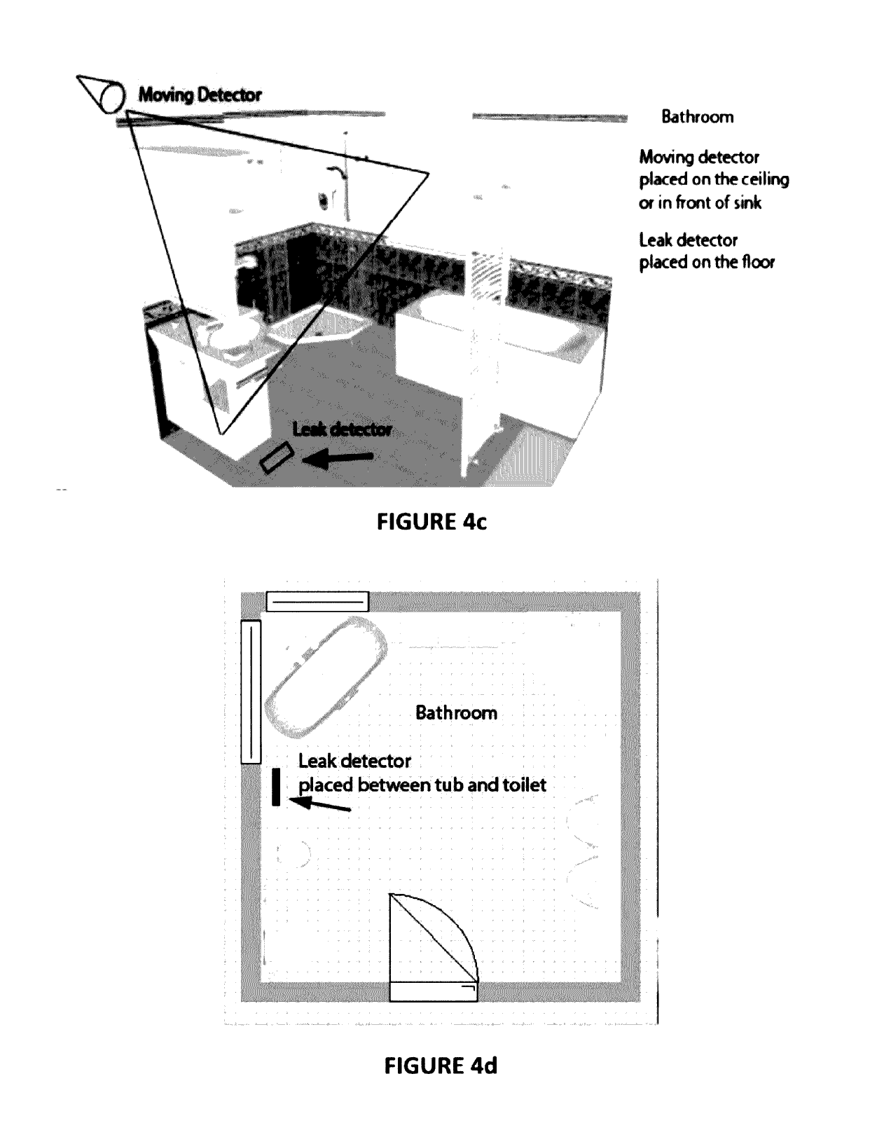

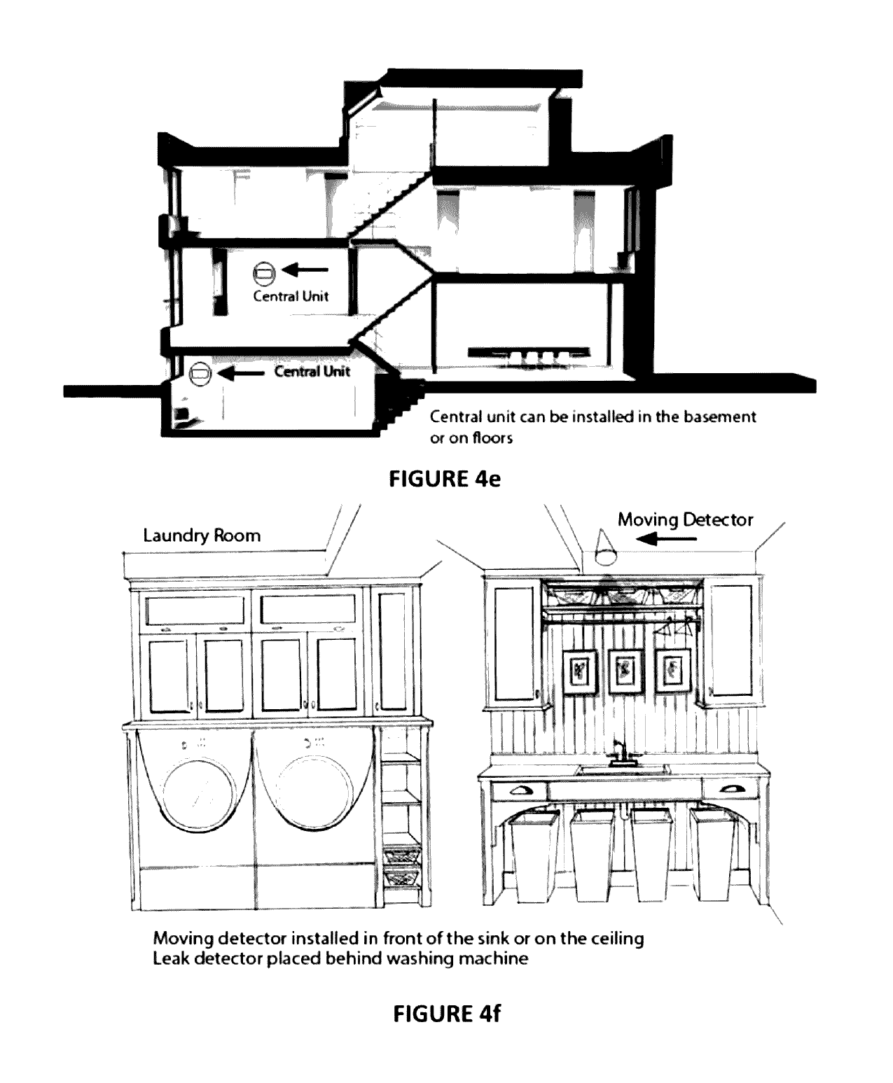

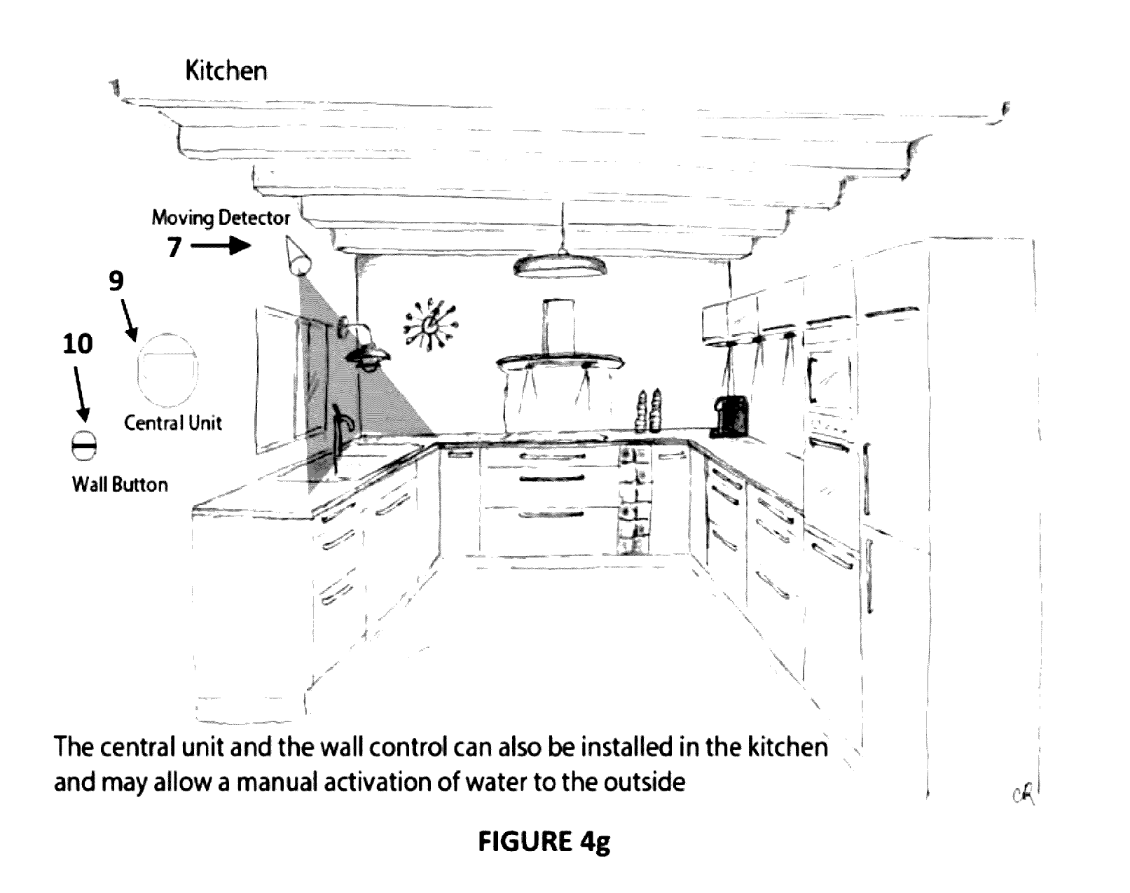

The system 1 also comprises at least one sensor 7 for detecting activities occurring in the vicinity of the plumbing system, such as in the vicinity of a faucet, of a shower, entering the bathroom, in the kitchen, or with the CT when there is a request from an appliance, and remain open for a given time period that can be set up by a timer. It is to be understood that the system may also be operated manually. The user can set an open or closed status of the valve, for a finite or indefinite period of time, directly on the central unit 9, from a switch button device 10 (see for instance FIG. 4g) for indoor and outdoor use, or from the interface of a computer or of a mobile phone.

Each sensor 7 is operatively connected to the electronic valve mechanism 3.

The system 1 also comprises a computerized control unit 9, also named central unit or terminal, in communication with the electronic valve mechanism 3 and each sensor 7 for controlling the opening and closing of the valve 3. The control unit 9 is adapted to be programmed to maintain the valve in an inoperative position or locked thanks to the electronic valve mechanism in the absence of activities detected by the said at least one sensor in or near the building.

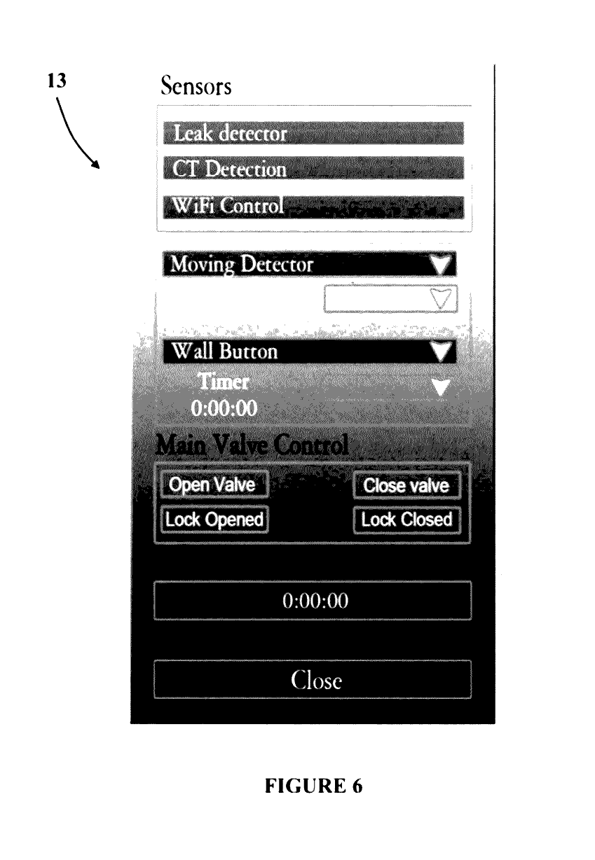

As illustrated on FIG. 1, the opening of the electronic valve 7 may be controlled by the central unit 9 connected to a set of sensors 7, which could be wirelessly and securely connected 11. The central unit 9 may further allow the user to control the system 1 via a unit interface 13 placed directly on the unit 9. The unit interface can be a touch screen for an easier control of the unit's operation. FIG. 6 shows an example of touch screen and interface that can be used with the control unit. Other known interface unit can be used.

The electronic valve 7 may also be controlled remotely through several types of interfaces, such as a web interface 15 can be accessed via a computer or mobile on the local network via WiFi or Bluetooth® systems or from outside via VPN or web address and a specific port pointed to the previously configured network.

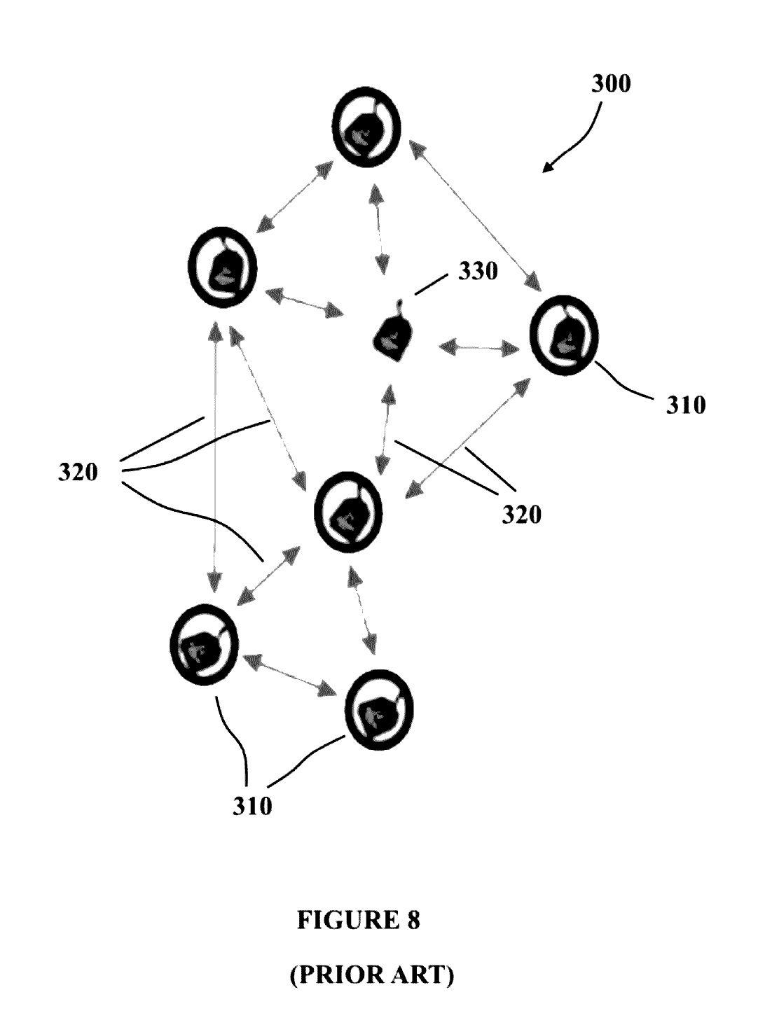

Local networks, independent of the Internet and provided with a independent power source, such as a battery, can be used within the scope of the present invention. For example, according to one preferred embodiment, the local network that can be used could be based on Xbee™ point-to-point mesh network technology, offering reliability, redundancy, security and independence in case of power failure. A mesh network is a local area network that employs one of two connection arrangements, full mesh topology or partial mesh topology. In the full mesh topology, each node (workstation or other device) is connected directly to each of the others. In the partial mesh topology, some nodes are connected to all the others, but some of the nodes are connected only to those other nodes with which they exchange the most data. The illustration of FIG. 8 shows a full mesh network 300 with 7 nodes 310 and a coordinator 330. The connections for a mesh network 320 can be wired or wireless, more preferably wireless. A mesh network is reliable and offers redundancy. If one node can no longer operate, all the rest can still communicate with each other, directly or through one or more intermediate nodes. Mesh networks work well when the nodes are located at scattered points that do not lie near a common line.

The central unit 9 may comprise a processor 17, such as but not limited to a Colibri™ iMX6 512 MB, including a unit interface 15, such as a graphical touch screen 13, to allow users to interact, configure and set up the various sensors and actuators forming part of the system, thereby controlling the system. The central unit 9 may typically comprise at least one Ethernet port 19, at least one USB™ port 21, one HDMI™ port 23, one mesh Xbee™ Module 25, and terminals for wired connection.

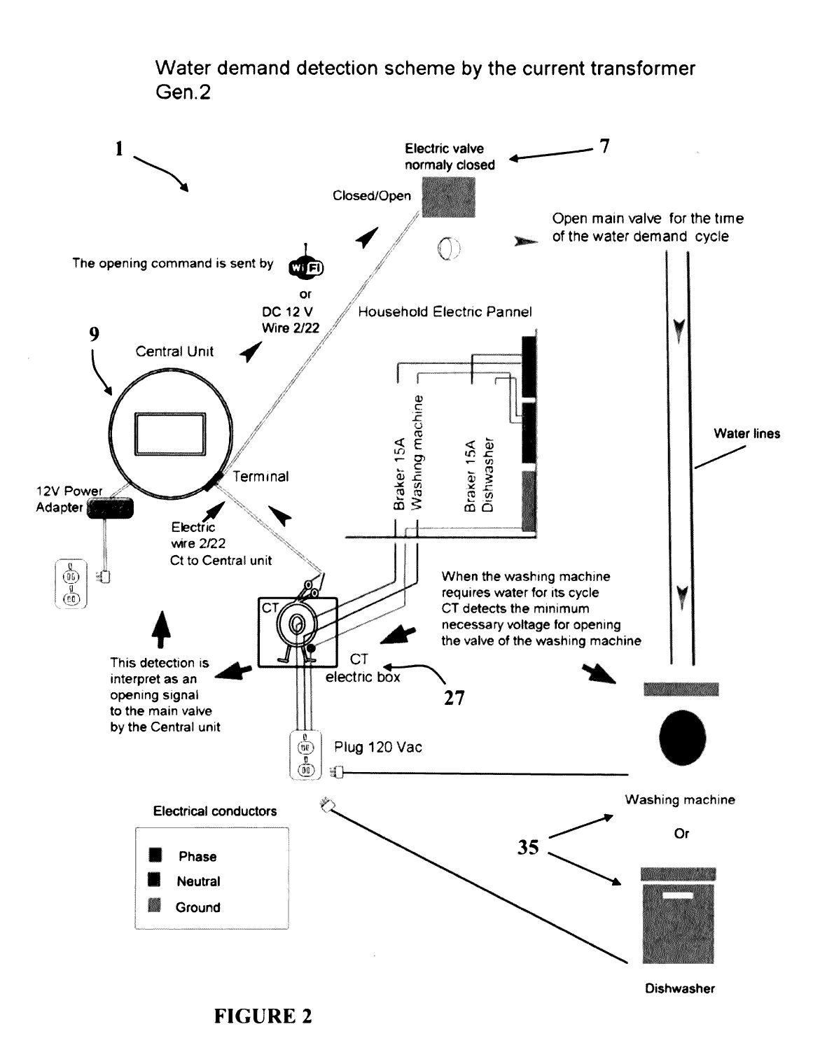

The central unit 9 is electrically powered, typically by 12 V DC current, as shown on FIG. 2. A battery module may be provided to serve as an auxiliary power source, which may be installed in the central unit 9, and which may be charged independently or through the electronic circuit of the system.

The system shall typically also comprise sensors and actuators, including one or more motion detectors 7 one or more current transformers 27, and one or more leak detectors 29.

The central unit 9 may be connected, by wire or wireless, to the electronic valve mechanism 3, and may be located near the main valve 5 or not, on the same or different floor of the building or residence. It may also be made part of an overall building automation system or home automation system. It will preferably be installed in a convenient location that can be either close to the main valve 5, on a wall or on the floor.

The central unit 9 may be connected, by wire or wireless, to the various sensors and actuators 7, 27, 29, preferably by a mesh network 31 not connected to the Internet grid, which signal is to be generated by a router 33 located in the central unit 9.

Motion detectors 7 may be of a standard type found in the industry, such as, for example, of the Wireless PIR Motion Sensor VS-WH500 model, or the Wired Outdoor Motion Sensor VS-YH800 model, or BOSCH™ isc-bpr2-wp12 model, and can be located at such places in residence, where a detection of movement shall typically mean a wish or need by user to have access to water, such as in bathrooms, or close to showers. FIGS. 4a to 4e illustrate typical locations of motion detectors 7 in a residential housing. When the system 1 is installed in commercial, industrial or institutional buildings, the location of such detectors shall be adapted accordingly.

Referring to FIG. 2, current transformers 27 (herein referred to as CT), such as, for example, of the Hawkeye™ 300 go/no go model, are adapted to detect milliampere signals typically generated by solenoids installed in standard appliances 35, such as washing machines and dishwashers, to trigger the opening of the appliance's valve, when income of water is required. When such signal is detected by current transformers 27, a signal is sent to the central unit 9, which in turn sends a signal to the valve 7 to open it. Reciprocally, when the appliance 35 sends a milliampere signal to trigger the closing of the appliance valve, when income of water is no longer required, such signal shall be detected by current transformers 27, which then sends a signal to the central unit 9, which in turn sends a signal to valve 7 to close it. Other appliances, such as certain refrigerators, requiring water supply for ice, some air conditioners and water dispensers, are also equipped with a solenoid that work the same way.

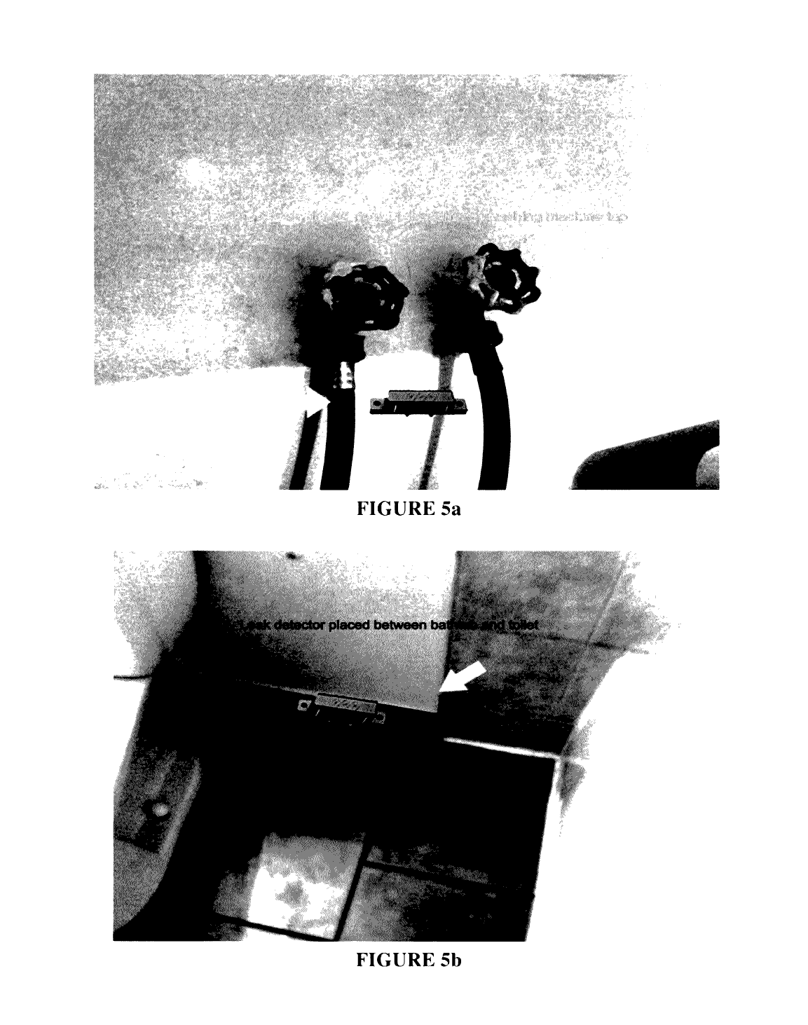

Leak detectors 29 may be of a standard type found in the industry, such as, for example, of the Rialco™ 84010 Flood Alarm type. They are typically located at those strategic points, such as, in a residential environment, in toilets, in the basement. Typically, this detector detects water to a thickness relative to the floor, of about 1 mm, where eventual water leaks may occur. FIGS. 5a and 5b illustrate some typical locations of leak detectors 29 in a residential housing. When moisture is detected by a leak detector 29, it shall send a signal to the central unit 9, which in turn shall send a signal to valve 7 to close it.

Thus the opening of the valve 7 may be actuated by a set of sensors connected to the central unit 9, typically connected wirelessly.

The central unit 9 may also comprise a control interface accessible via a unit interface 13 located on the central unit 9, allowing for direct control of the valve 7 through actuation of virtual buttons associated with signal to operate the valve 7, as shown at FIG. 6.

The system 1 may also provide for a switch on/off push button device 115, such as, for example, a DSC™ Wireless Wall Plate Keypad, having programmable function keys, of the WS4979 model, to allow a user to open or activate the main valve 40 when entering the premises and installed on the wall, or as remote control handle, for indoor or outdoor use.

The system 10 may also comprise other means to remotely control the valve 40, for better flexibility in the control of the aquifer system, such as several types of interfaces available, through web interfaces. The web interface provides access to all data and options for the user. As discussed later, it allows also, when user has opted for a supervising service, for administrator to configure and monitor the system, and supply data, such as statistical compilation.

Such web interface may be accessed via a computer or mobile phone on the local network via wireless connection using WiFi or Bluetooth®, or from outside via VPN or web address and a specific port pointed to the previously configured network. Mobile interfaces are configured to access the network from both inside and outside the network.

A similar interface may also be made available from a website.

In operation, the system 10 controls the main valve 40, such as an electronic valve mechanism, located at the main entrance of the arrival of water in a building.

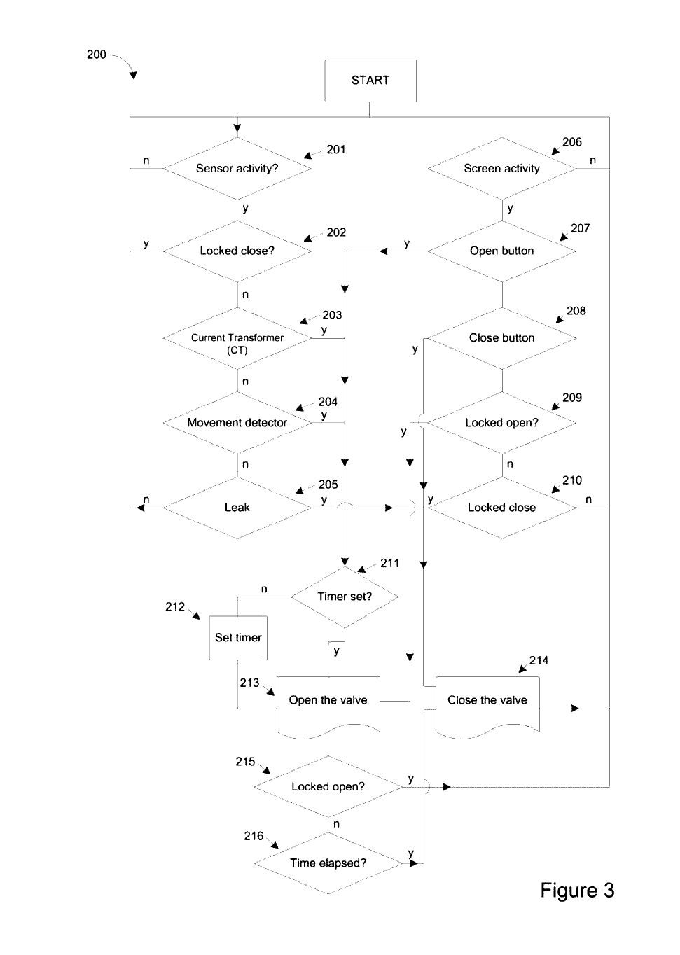

Referring to FIG. 3, a method for controlling water pressure is shown.

The method 200 may include a step of seeking for the detection of a sensor activity 201 on a sensor, such as a current transformer sensor 27, a movement detector sensor 7, or a leak sensor 29, or a screen activity, such as on the screen 13.

Should a sensor activity be detected, the system will verify if the Locked Close option 202 has been selected on the screen; in the affirmative, no further action would take place and the system will evolve in the closed position, until further activity.

In the negative, if a detection of current transformer sensor 203 or movement sensor 204 is affirmative, the system will verify whether a timer value 211 has been selected, whether automatically or manually; in the negative, an instruction 212 prompting to set the timer will be induced; in the affirmative, the valve will be opened 213, and shall remain open up until the system has detected that the set-up time is elapsed 216, in which case the system shall send a system to close the valve 214, and the valve shall remain so closed until further activity is detected.

The last instruction shall not take place if prior to instruction 216, the system has detected that the Locked Open option 215 has been selected, in which case, the valve shall remain open, until further activity.

A timer may be set at a pre-established time value. For example, should motion sensor 7 detect a presence, it may request an opening for two minutes, or other settings. For example, 15 minutes may be selected for the duration of a shower.

If the valve 7 is not in a locked closed position, a signal to open the valve 7 is sent to the valve. If the valve 7 is not in a locked open position, the timer signal starts running and, when the time has elapsed, a signal is sent to close the valve and the system is reinstated in its initial position.

If a leak sensor activity 205 is detected, the system shall send a signal to close the valve 214, and the valve shall so remain until further activity.

Should a screen activity 206 occur, it may initialize a number of instructions, as seen in FIG. 6.

If the open button 207 is activated, the timer 211 shall be set either at a default value or at a value set up by the user 212. Upon completion of that step, a signal shall be sent to the valve to open 213 and, if the valve is not locked open 215, the valve shall remain open until the time set by the user is elapsed, upon which the valve shall be closed and then, the system shall be reinitialized at its initial position.

If the close button 208 is activated, a signal shall be sent to the valve to close 214 and then, the system shall be reinitialized at its initial position.

If the Locked open button 209 is activated, a signal shall be sent to the valve to open 213, and the valve shall remain open, until an instruction is sent by user to close 214, upon which the valve shall be closed, and then, the system shall be reinitialized at its initial position.

If the Locked close button 210 is activated, a signal shall be sent to the valve to close 214, and the valve shall remain close, until an instruction is sent to unlock, and then the system shall be reinitialized at its initial position.

The system and method according to the present invention allows building owners to control the water pressure from distance. This is of particularly of interest when the user is far from the building, such as a country house. As aforesaid, the system 1 can be controlled using a Smartphone or tablet application adapted to the system and to the central unit connected via internet connection or mobile telecommunication systems (3G, 4G or the like).

As shown on FIG. 1, the system may comprise wireless system controller units, which shall consist of applications installed on any smartphone 15, or at a website on any laptop computer giving access to an interface that will allow the users to send instructions to configure the system operating parameters (using same semantics as above).

Typically, the applications to be installed on any smartphone, to be programmed for Apple™/i0S-OS X™ for applications to be made available on Apple Store™, or for Android™ applications to be made available on Play Store™ for Google™, shall provide for a mobile user interface compatible for phones and/or tablets.

The system may also comprise monitoring components to assist service providers to properly monitor, supervise and assist users. These may also comprise a statistic module and a watchdog module.

The information is relayed to the monitoring station securely where technicians can view the data of all installations to be monitored. Technicians can remotely control valves or communicate with clients in emergency or critical situations such as when a breakdown occurs.

The central server system also allows analysis and reporting. It is also possible to use an API previously activated to communicate with the systems via scripts or custom applications. Using the API allows full control of automated way and saving of statistical data in a remote system

The statistic module may generate statistics from sensor readings, stored in a database, allowing user to supervise in readily available formats, such as under daily, weekly, monthly or yearly comparative formats.

The application allows visualization of use, with statistics recorded in the database. Installation of customers who opted for a remote monitoring service communicates via a secure virtual private network or CLOUD with a central system of servers that can analyze the response of sensors and real-time valve.

The watchdog module may also comprise a software watchdog module, which verifies in real time the functioning of the system, monitoring in particular the proper interruption sequence of the valve. It may reset the system when necessary while saving all necessary system parameters. It may also comprise an equipment watchdog module which supervises the power supply in order to ensure that it remains within its proper operating range and supervises also critical communication signals. In case of failure detection, it switches to an auxiliary power supply, which performs a reset of the main power and then restores the main power.

The supervision of the various sensors of the system is ensured by sensor reading module hardware interface that allows the interconnection between the control electronics and the various sensors of the system, which ensures the validity of surveys performed on the sensors.

### Business Method

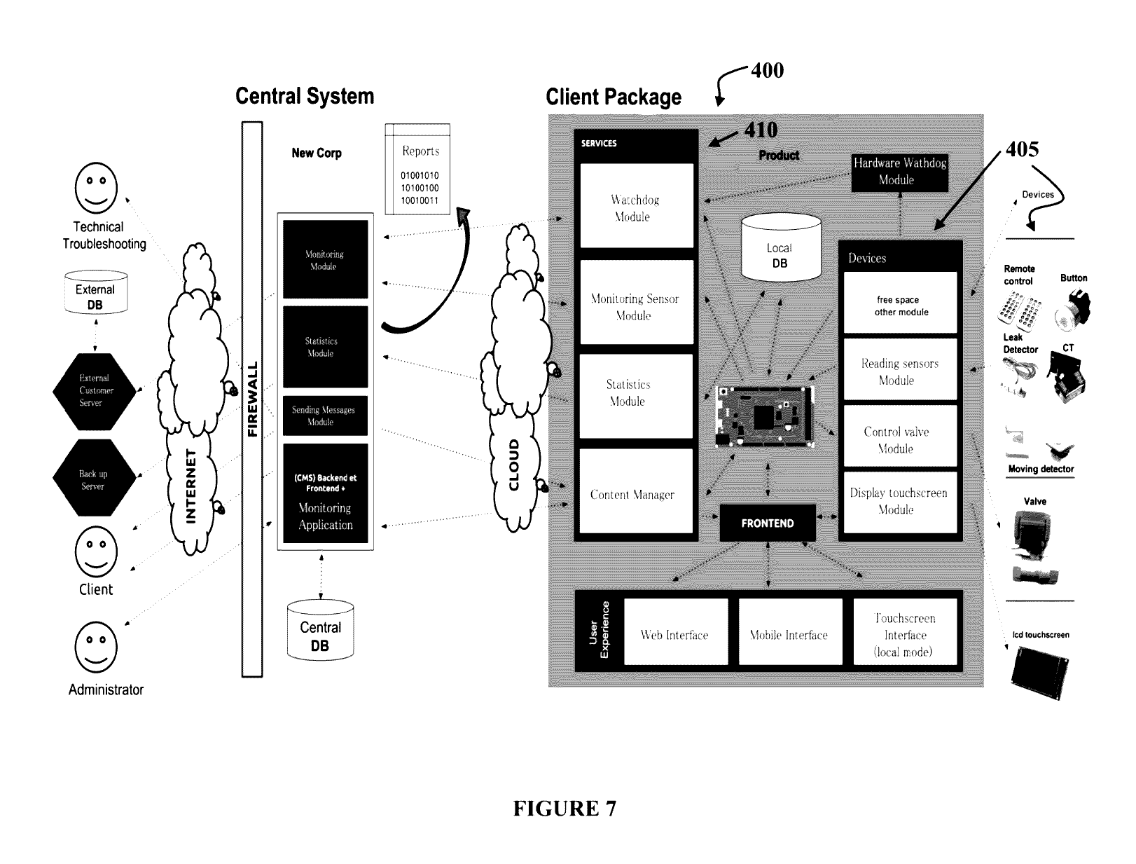

As aforesaid, the present invention also concerns a business method of providing surveillance and maintenance services for a plumbing system of a building to members of an organization. FIG. 7 illustrates the different steps and elements regarding the business method.

The method comprises the first step of:
a. offering membership in the organization that provides surveillance and maintenance services for the plumbing system of the building; the building being equipped with the computer-implemented system as defined herein to automatically control a valve located at the main water or gas entrance of a building.

The organization offering the service, or client package 400, can be for instance the same organization or company providing the wireless control system disclosed herein and installed the different devices 405 in the building by the member or by the organization for the member. The membership or client package, 400 can comprise different levels of services or modules 410, each level comprising different tasks or actions that must be accomplished by the organization.

The services or modules 410 can comprise, but are not limited to, watchdog module, monitoring sensor module, statistics module or content manager.

The method comprises the second step of:
b. receiving requests for membership in the organization from prospective members.

The requests can be done via the website of the organisation, a mobile application thereof, by telephone or other known communication canals. The request can also be done when the member purchased the home automation systems from the organisation, or the membership can be included with the purchase of the home automation system.

The method comprises the third step of:
c. granting membership to prospective members that requested membership in the organization and satisfy pre-determined criteria required for membership.

The method comprises the fourth step of:
d. receiving requests from the members of the organization to monitor the plumbing system when said members are away from the building for a period of time.

The method comprises the fifth step of:
e. providing the surveillance and maintenance services to the members of the organization who requested said services.

According to a preferred embodiment, the surveillance and maintenance services of the business method are emergency surveillance and maintenance services.

According to a preferred embodiment, the surveillance and maintenance services are provided twenty-four hours a day and seven days a week.

According to a preferred embodiment, the method further comprises the step of notifying the members when the maintenance and surveillance service has been used or is completed. Preferably, the method further comprises the step of requesting the members to provide feedback regarding the services or products the members have received.

The membership can be provided to members that have purchased and installed the wireless home automation systems in accordance or the invention.

For example, one member has installed the wireless home automation systems in a country house. The organisation is alerted if the system detects a movement in the building and/or the valve is opened. If the member is not aware of the presence of a person, such as him or herself, in the building, the member can request the organization to close the valve until further verification is done. Alternatively, the member can directly close the valve using the computer-implemented application or organization's website interface.

Different options of surveillance and maintenance can be offered to the member in accordance of different membership levels.

For example, the member can inform the organisation that a building should be unoccupied for a given period of time. In case movement and opening of the valve occurs during said given period of time, the organization maintains the valve closed until the member has been alerted by the organization and has given authorisation to reopen the valve.

The wireless home automation system thus provides security surveillance of empty buildings combined with a surveillance of the building from water flood or gas leak.

Other services can be offered as well to the member in accordance of different membership levels, such as statistics, allowing the member to monitor its consumption, watchdog services, ensuring technical supervision of software and hardware modules.

### System Installation

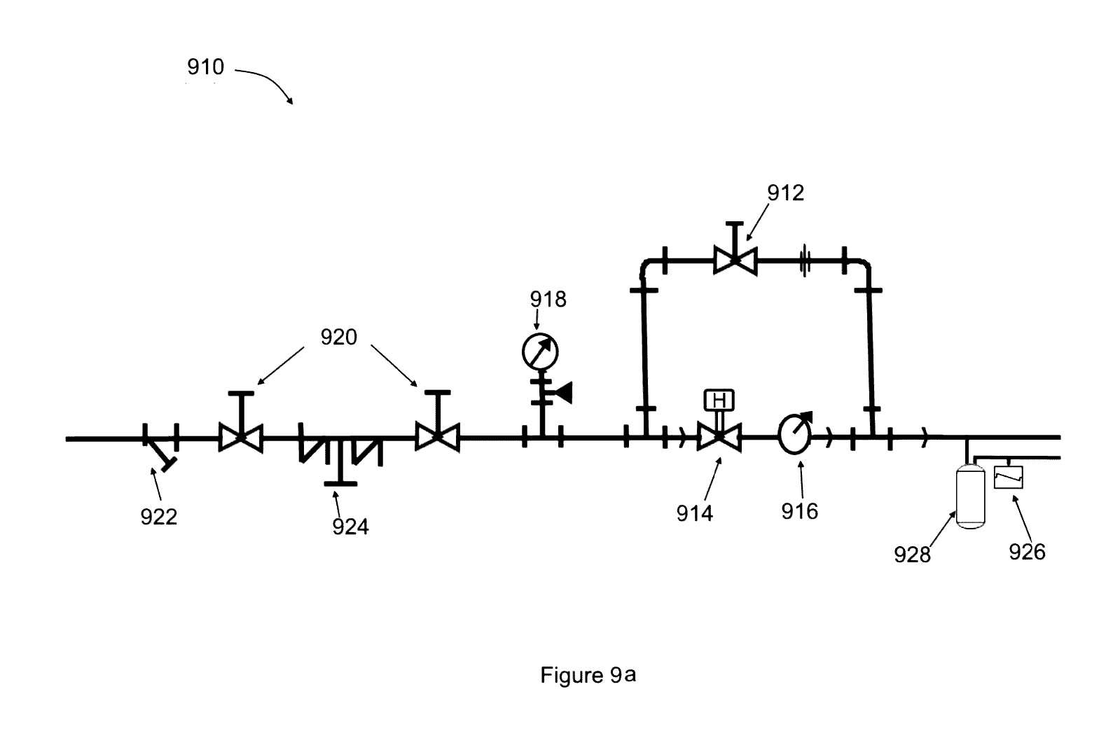

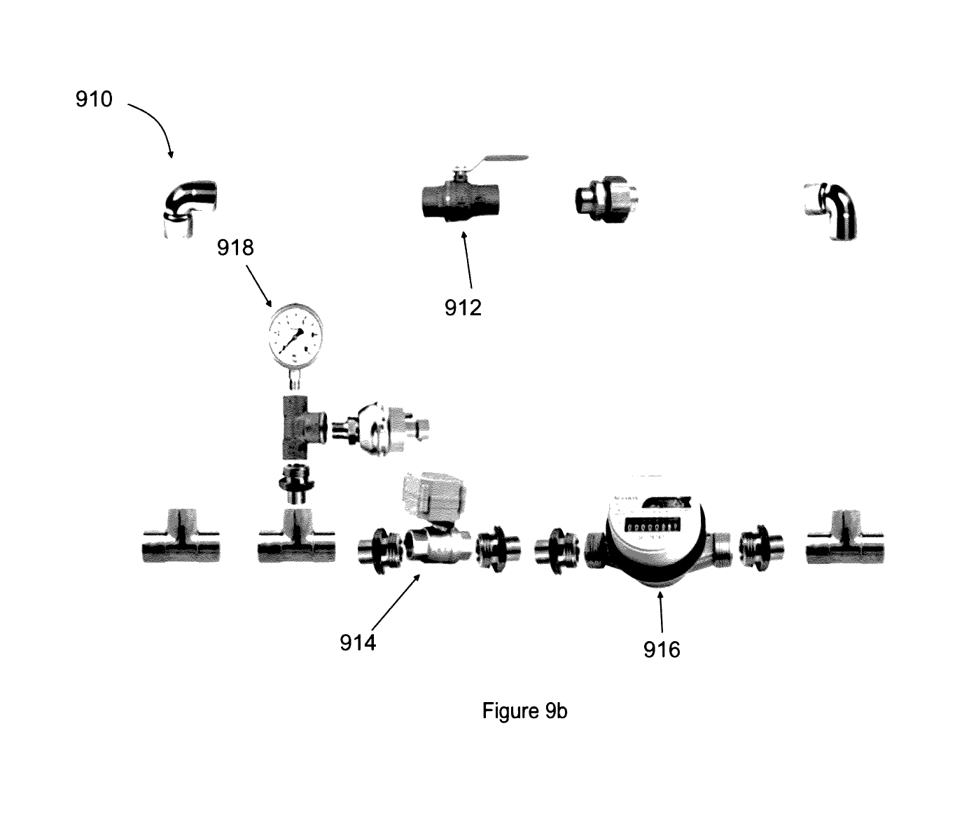

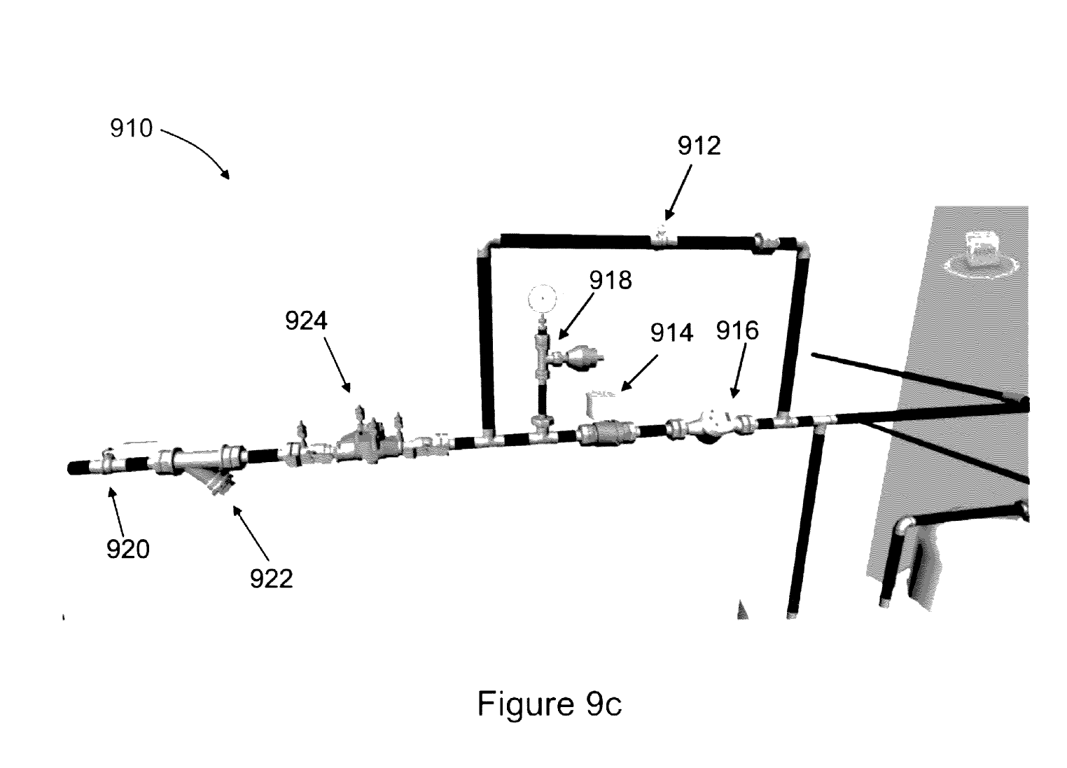

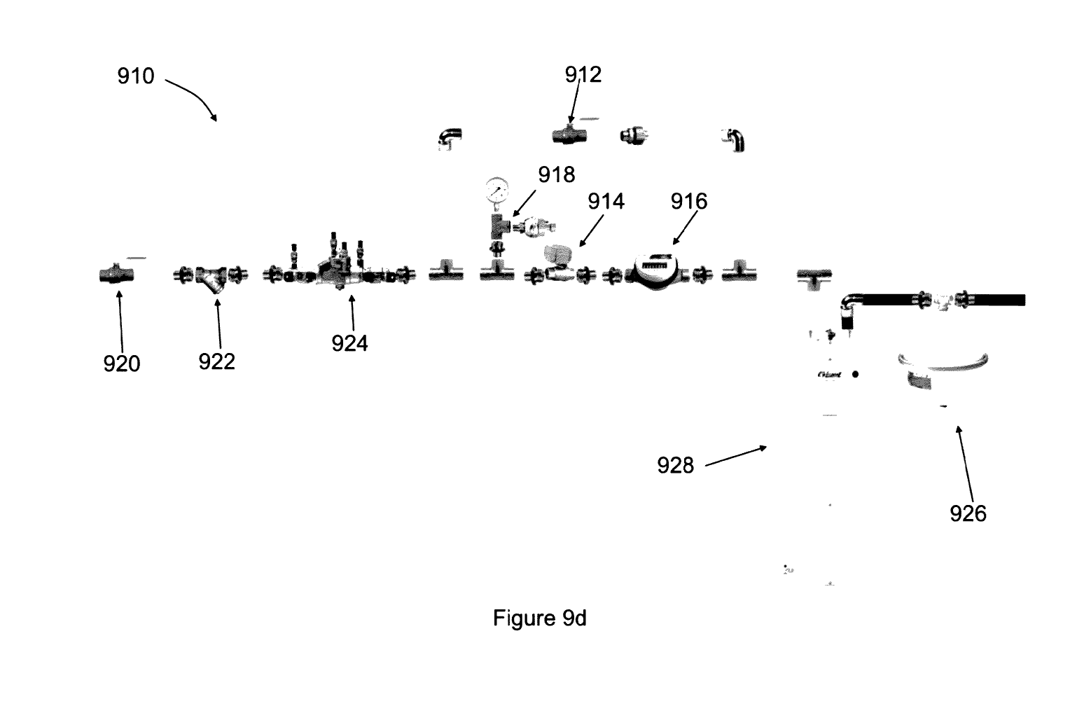

FIG. 9a illustrates an installation scheme of the hydraulic system in accordance with the principles of the present invention. The system 910 comprises a by-pass valve 912 to secure the system in case of a malfunction of the electric valve 914. A water-meter 916 may be also used if required by local municipality rules. A pressure gauge 918, hand operated globe valves 920, a Y-strainer 922, and an anti-backflow device 924 may also be used, or other plumbing parts known in the art can be used for installing the system.

The by-pass valve 912 is fluidly connected in parallel to the electric valve 914 allowing water to be provided to the appliances in case of failure of the electronic valve 914. If the electric valve 914 is locked in the closed position, a user can manually activate the by-pass valve 912. The water then normally flows in the pipes until the electric valve 914 is fixed or changed.

Still referring to FIG. 9a, the water may be stored and heated in a water tank 928, such as those known in the art. However, because the volume of the water in the tank 928 may increase with higher temperature, an expansion tank 926 can be connected downstream the valve in order to receive excess water and also to avoid any unnecessary stress on the pluming system. For instance, the pressure gauge 918 may be used to notify the user of an exceeding water pressure. The pressure gauge 918 may also be connected to the system 910 to open the valve if the pressure exceeds a given threshold.

FIGS. 9b to 9d are more representative illustrations of a typical installation of the system 910 in accordance with the principles of the present invention.

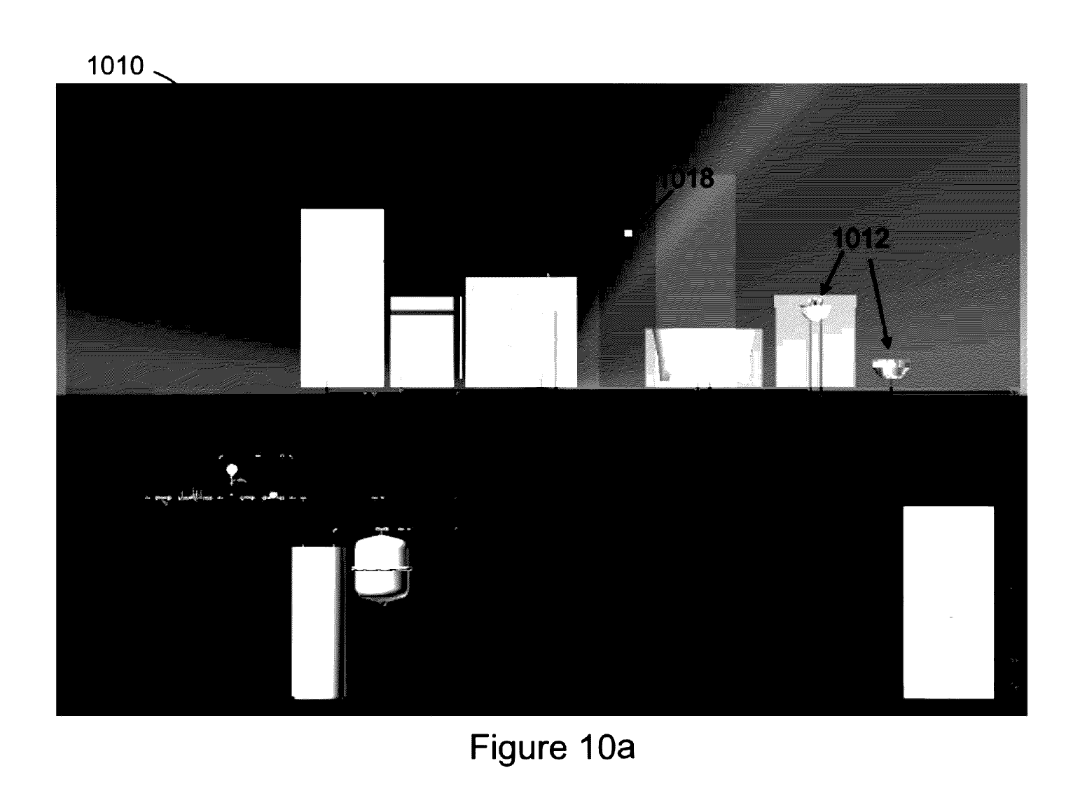

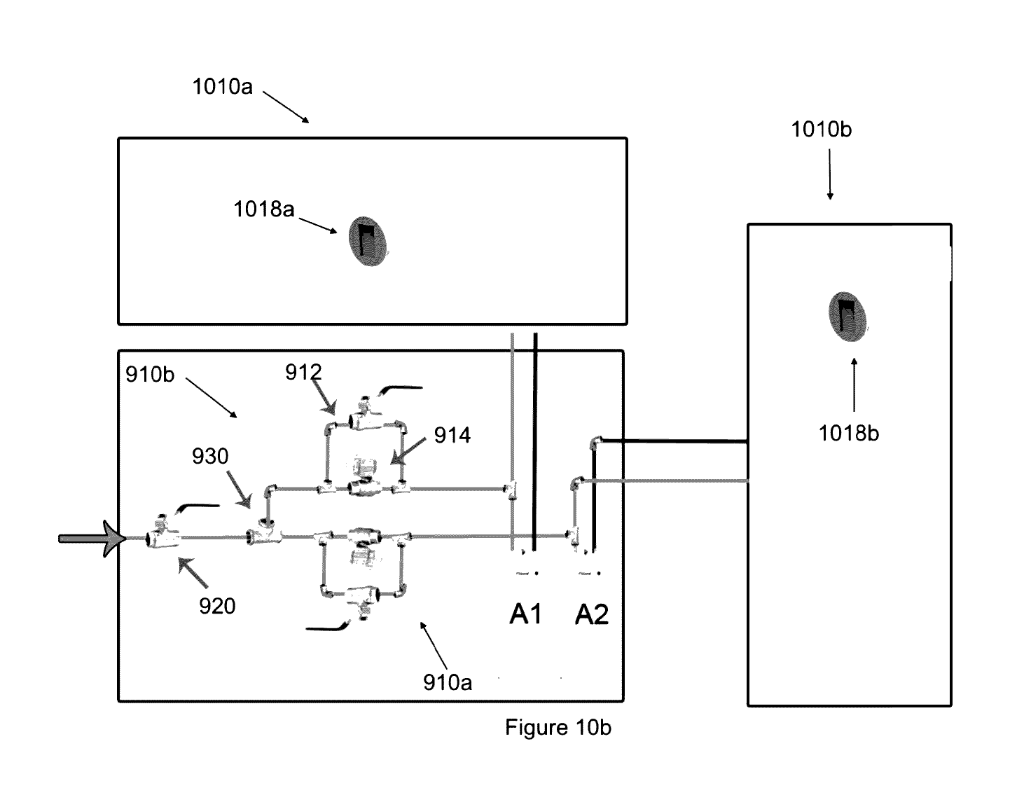

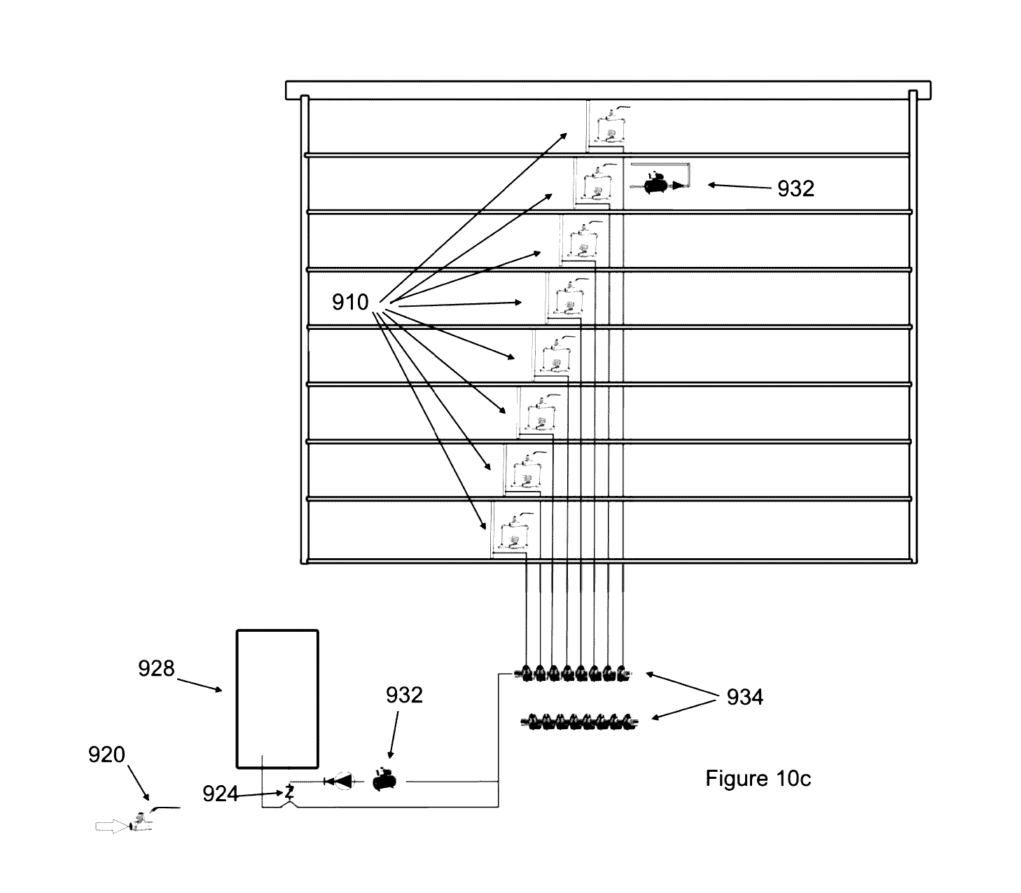

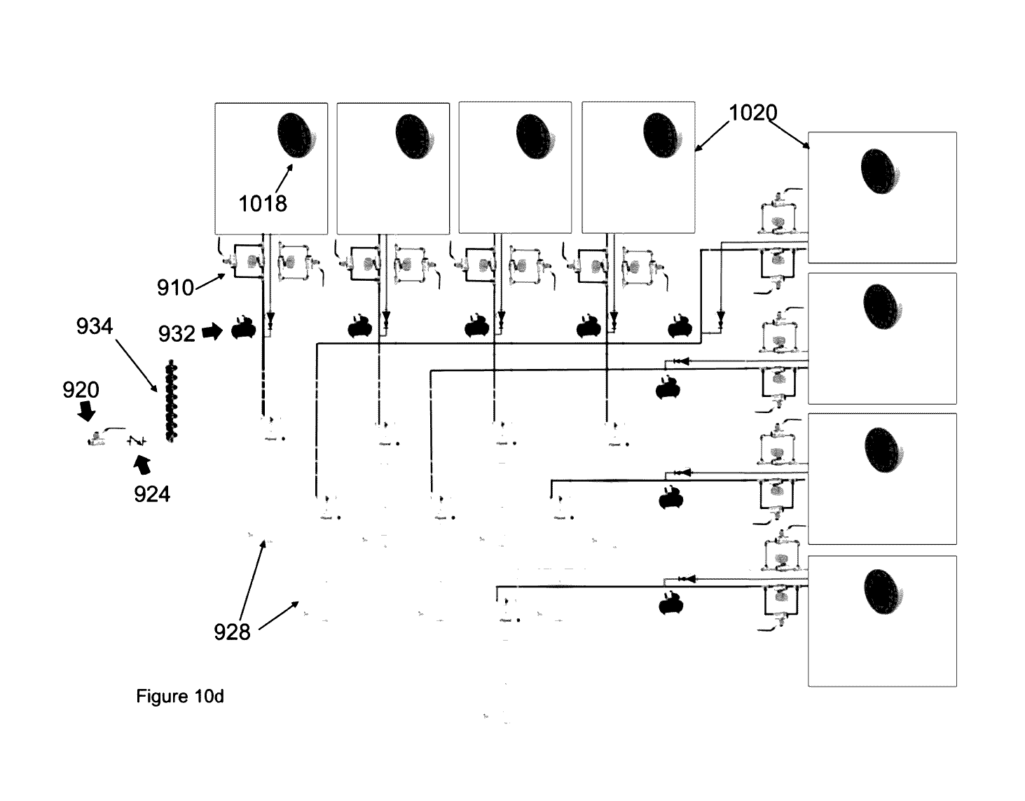

FIG. 10 illustrates typical installations of the system. More specifically, FIG. 10a represents a possible installation of the system 910 in a family house 1010. The system 910 is connected to all the appliances that use water, such as, but not limited to, sinks 1012, a bath 1014, and/or a dishwasher 1016 or a washing machine. A control unit 1018 operatively connected to the system can be installed in one of the rooms of the house to control the system 910.

FIG. 10b illustrates an installation similar to the one illustrated in FIG. 10a but in a duplex of two apartments 1010a and 1010b. In such a case, two water tanks A1 and A2 are used such that each apartment has its own access to hot water. Each tank, A1 and A2, is connected to their respective system 910a and 910b comprising the electric valve 914 and by-pass valve 912. Both systems are connected to the main valve 920 of the building. A separator 930 is used to provide water to both systems 910a and 910b.

In each apartment 1010a and 1010b of the duplex, a control unit 1018a and 1018b is operatively connected to a respective system 910a and 910b. In such a case, the control unit 1018a of the apartment 1010a is adapted to only control its associated system 910a. In the same manner, the control unit 1018b of the apartment 1010b is adapted to control the system 910b.

FIG. 10c illustrates a typical installation in a condominium. In such cases, each apartment has its own system 910. However, all apartments are hooked on the same general water tank 928, which is preferably of an industrial type. The hot and cold water are divided using splitters 934 to provide water to each apartment. Also, since water shall be routed from the basement of the building to all stories, a device, such as, but not limited to a compressor 932, shall be used to increase the water pressure such that all tenants have an adequate water flow rate. An additional compressor 932 may be required in some apartments that are above a threshold height from ground level. Each apartment of the building shall be equipped with is own control unit.

FIG. 10d illustrates a typical installation in a hotel. In this case, each room 1020 has its own control unit 1018 and its own water tank 928. Each control unit 1018 is preferably connected to a system 910. An anti-backflow valve 924 may be connected downwind of the main building valve 920. A splitter 934 is used to divide the water to the systems 910 and water tanks 928 of each room. A compressor 932 may be used to increase the water pressure.

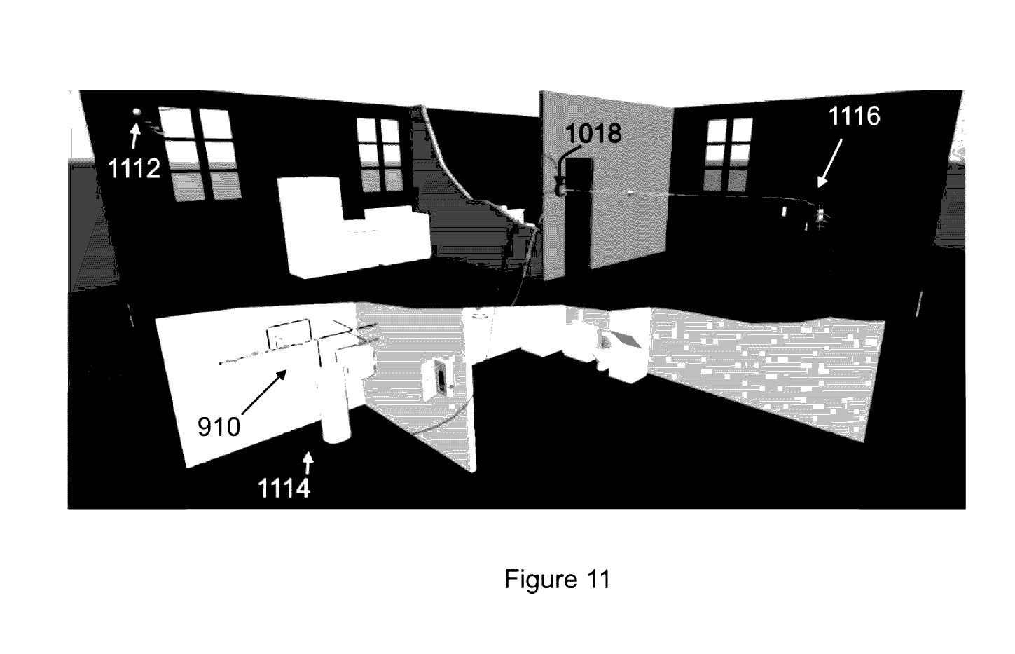

FIG. 11 illustrated a typical installation in a house is illustrated. The system 910 comprising the electronic valve 914 and the by-pass valve 912 is preferably located in the basement. The control unit 1018 is adapted to receive input signal from a movement detector 1112 and a leak detector 1114. The control unit 1018 may also be connected on a server 1116. In the present embodiment, the control unit 1018 is adapted to move the valve 914 from a closed position to an open position if the movement detector 1112 detects presence of a tenant in a room. The tenant is thus able to normally use any of the appliances such as a sink, a bath, a toilet, or the like installed in the room. The valve 914 may then move from the open position to the closed position when the tenant leaves the room. To the contrary, if the leak detector 1114 detects the presence of a fluid, it shall instruct the control unit 1018 to shut the valve 914 to avoid any water damage. A similar system may be installed in each room of a hotel.

It is to be noted that although the preferred embodiments have been described as a system to control water distribution, a similar system may also be used to control a gas distribution in a building, such as, but not limited to, natural gas or propane. In such a case, a system according to the invention can be installed close to the main entrance water line and the main entrance gas line. A sole control unit may be adapted to control both systems or two control units may be used.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A computer-implemented system to automatically control fluid distribution in a building, the system comprising:
a valve located at a main entrance of a fluid distribution system of the building;
an electronic valve mechanism operatively connected to the valve to open or close the valve;
at least one sensor for detecting activities occurring in or near the building, each sensor being operatively connected to the electronic valve mechanism; and
a computerized control unit in communication with the electronic valve mechanism and each sensor for controlling the opening and closing of the valve;
wherein the computerized control unit comprises at least one processor and a computer-readable medium having stored thereon computer-readable instructions that, when executed, cause the processor to:
command the electronic valve mechanism to maintain the valve in locked position in the absence of activities detected by the said at least one sensor in or near the building, or
command the electronic valve mechanism to open the valve when an activity is detected by the said at least one sensor.

2. The system of claim 1, further comprising a by-pass valve fluidly connected in parallel to the valve and the electronic valve mechanism to allow a person to open the circulation of the fluid even if the valve is closed or in case of a malfunction of the electronic valve mechanism.

3. The system of claim 2, wherein the by-pass valve is manually operated by the person.

4. The system of claim 1, further comprising an anti-backflow valve fluidly connected to the main fluid entrance and upwind of the electronic valve mechanism to protect the valve and the electronic valve mechanism from a backflow.

5. The system of claim 1, wherein the fluid is water.

6. The system of claim 1, wherein the building comprises a plurality of apartments, each apartment comprising its own valve and electronic valve mechanism and at least one sensor.

7. The system of claim 1, wherein the building is a hotel comprising a plurality of hotel rooms, each room comprising its own valve and electronic valve mechanism and at least one sensor.

8. The system of claim 1, wherein the activities are selected from a group consisting of a movement in a room, a fluid leakage in the room, and an appliance requiring incoming fluid.

9. The system of claim 8, further comprising a current transformer operatively connected to the appliance and adapted to send a signal to open the electronic valve mechanism when an income of fluid is required by the appliance.

10. A computer-implemented method to automatically control fluid distribution in a building, the method comprising the steps of:
c) detecting at least one activity using at least one sensor located in or near a building, each sensor being operatively connected to an electronic valve mechanism operatively connected to a valve, the electronic valve mechanism being adapted to open or close the valve; and
d) sending information detected in step a) to a computerized control unit in communication with the electronic valve mechanism and each sensor to command the electronic valve mechanism to open the valve if activities are detected in step a), or to keep the valve closed if no activity is detected in step a).

11. The method of claim 10, wherein the fluid is water, the method further comprising the step of measuring a water pressure upwind of the valve, and increasing the water pressure if said pressure is below a given threshold.

12. The method of claim 10, further comprising the step of detecting a malfunction of the electronic valve mechanism and by-passing the valve and electronic valve mechanism by manually opening a by-pass valve fluidly connected in parallel to the valve and the electronic valve mechanism to allow circulation of the fluid even if the valve is closed.

13. The method of claim 10, wherein the activities are selected from a group consisting of a movement in a room, a fluid leakage in a room, and an appliance requiring incoming fluid.

14. The method of claim 13, further comprising the step of sending a signal to open the electronic valve mechanism when an income of fluid is required by the appliance.

15. The method of claim 14, wherein the signal is sent using a current transformer operatively connected to the appliance.

16. A business method of providing automatic surveillance and maintenance services for a plumbing system of a building to a member of an organization, the building being equipped with a computer-implemented system as claimed in claim 1, the method comprising performing the steps of:
e) offering membership in the organization that provides services for the plumbing system of the building;
f) receiving requests for membership in the organization from prospective members;
g) granting membership to prospective members that have requested membership in the organization and satisfy pre-determined criteria required for membership;
h) receiving requests from the members of the organization to monitor the plumbing system when said members are away from the building for a period of time; and
i) providing the surveillance and maintenance services to the members of the organization who requested said services.

17. The method of claim 16, wherein the surveillance and maintenance services are:
notifying the members if a fluid leakage in a room is detected;
notifying the members if an appliance requiring an income of fluid is used; and/or
allowing the members to send a signal to the electronic valve mechanism to lock the valve.

18. The method of claim 16, further comprising the step of notifying the members when the maintenance and surveillance services have been used.

19. The method of claim 16, wherein the requests are made via a website of the organization, a mobile application, or a telephone.

20. The method of claim 16, wherein one of the pre-determined criteria is having bought and installed the computer-implemented system.
